(19) United States
(12) Patent Application Publication
(10) Pub. No.: US 2016/0114794 A1
(43) Pub. Date: Apr. 28, 2016

(54) VEHICLE TRAVEL CONTROL DEVICE

(71) Applicant: TOYOTA JIDOSHA KABUSHIKI KAISHA, Toyota-shi (JP)

(72) Inventor: Eiji SAKAGUCHI, Susono-shi (JP)

(73) Assignee: TOYOTA JIDOSHA KABUSHIKI KAISHA, Toyota-shi (JP)

(21) Appl. No.: 14/855,565

(22) Filed: Sep. 16, 2015

(30) Foreign Application Priority Data
Oct. 24, 2014 (JP) 2014-217432

(51) Int. Cl. B60W 30/02

(52) U.S. Cl. CPC B60W 30/025; B60W 2550/142; B60W 2550/146; B60W 2550/143

(57) ABSTRACT

A vehicle travel control device 1 includes a length acquisition unit 11 that is configured to acquire a length of a curve based on map information around a vehicle X, a determination unit 12 that is configured to determine a necessity of deceleration control of the vehicle X in the curve based on the acquired length of the curve, and a control unit 13 that is configured to execute the deceleration control of the vehicle X in a case where it is determined by the determination unit 12 that the deceleration control of the vehicle X in the curve is necessary. The determination unit 12 determines that the deceleration control of the vehicle X is unnecessary in a case where the length of the curve acquired by the length acquisition unit 11 is smaller than the threshold value.

### BACKGROUND OF THE INVENTION

1. Field of the Invention

An aspect of the present invention relates to a vehicle travel control device.

2. Related Background Art

There is a control device that executes a control for deceleration of a vehicle when entering a curve (for example, refer to Japanese Unexamined Patent Application Publication No. 2003-048450 (Patent Literature 1)). The control device calculates a speed at which the vehicle can travel while keeping a travelling lane based on a curvature of the curve in front of the vehicle. Then, in a case where a current vehicle speed is higher than the calculated speed, the control device decelerates the vehicle.

### SUMMARY

In the control device disclosed in Patent Literature 1, the vehicle is decelerated in all of the curves regardless of the length of the curve. However, for example, there is a curve on which the vehicle can travel while keeping the travelling lane without decelerating the vehicle such as a curve which is short in length. If the vehicle is decelerated even in such a curve, it may be considered that the driver may feel an uncomfortable feeling.

Therefore, in the present technical field, a vehicle travel control device is required, which can suppress the uncomfortable feeling to the driver caused by the deceleration of the vehicle in the curve.

According to an aspect of the present invention, a vehicle travel control device is configured to be capable of executing a deceleration control of a vehicle based on a curvature of a curve in front of the vehicle. The device includes: a length acquisition unit that is configured to acquire a length of the curve based on map information around the vehicle; a determination unit that is configured to determine that the deceleration control of the vehicle is necessary in a case where the length of the curve acquired by the length acquisition unit is equal to or larger than a threshold value, and to determine that the deceleration control of the vehicle is unnecessary in a case where the length of the curve acquired by the length acquisition unit is smaller than the threshold value; and a control unit that is configured to execute the deceleration control of the vehicle in a case where it is determined by the determination unit that the deceleration control of the vehicle in the curve is necessary, and not to execute the deceleration control of the vehicle in a case where it is determined by the determination unit that the deceleration control of the vehicle in the curve is unnecessary.

In the vehicle travel control device, in a case where the length of the curve acquired by the length acquisition unit is smaller than the threshold value, the determination unit determines that the deceleration control of the vehicle is unnecessary. That is, in a short curve where the necessity of deceleration is low, the deceleration control of the vehicle is not executed. Therefore, the according to the vehicle travel control device, it is possible to suppress the uncomfortable feeling to the driver by the deceleration control of the vehicle in the curve.

The determination unit may use a larger value as the threshold value when the curvature of the curve becomes smaller. In this case, for example, even if the lengths of the curve in the two cases below are the same, it is more easily determined that the deceleration control of the vehicle is unnecessary in a case where the curvature of the curve is small and the necessity of deceleration is low (in a case of a gentle curve) than in a case where the curvature of the curve is large (in a case of a sharp curve). In this way, according to the vehicle travel control device, it is more easily determined that the deceleration control is unnecessary when the curvature of the curve becomes small. Therefore, it is possible to suppress the uncomfortable feeling to the driver caused by the low-necessity deceleration control.

The vehicle travel control device may further include a cant acquisition unit that is configured to acquire a cant in the curve. In a case where a cant sloping downward from the outside of the curve toward the inside of the curve is acquired by the cant acquisition unit, the determination unit may use a larger value as the threshold value when the cant becomes larger. In this case, for example, even if the lengths of the curve in the two cases below are the same, it is more easily determined that the deceleration control of the vehicle is unnecessary in a case where the cant sloping downward from the outside of the curve toward the inside thereof is large than in a case where the cant is small. Here, in a case where the cant sloping downward from the outside of the curve toward the inside thereof is large, it can be suppressed that the vehicle departs from the travelling lane toward the outside of the curve, and therefore, the necessity of decelerating the vehicle is low. In this way, according to the vehicle travel control device, it is more easily determined that the deceleration control is unnecessary when the cant sloping downward from the outside of the curve toward the inside thereof becomes larger. Therefore, it is possible to suppress the uncomfortable feeling to the driver caused by the low-necessity deceleration control.

The vehicle travel control device may further include a vertical gradient acquisition unit that is configured to acquire a vertical gradient in the curve. In a case where a vertical gradient of an upward slope is acquired by the vertical gradient acquisition unit, the determination unit may use a larger value as the threshold value when the vertical gradient becomes larger. In this case, for example, even if the lengths of the curve in the two cases below are the same, it is more easily determined that the deceleration control of the vehicle is unnecessary in a case where the vertical gradient of the upward slope is large and the necessity of deceleration is low than in a case where vertical gradient is small. In this way, according to the vehicle travel control device, it is more easily determined that the deceleration control is unnecessary when the vertical gradient of the upward slope becomes larger. Therefore, it is possible to suppress the uncomfortable feeling to the driver caused by the low-necessity deceleration control.

According to an aspect of the present invention, it is possible to suppress the uncomfortable feeling to the driver caused by the deceleration control of the vehicle in the curve.

### BRIEF DESCRIPTION OF THE DRAWINGS

FIG. 1 is a diagram illustrating a schematic configuration of a vehicle on which a vehicle travel control device is mounted in a first embodiment.

FIG. 2 is a diagram illustrating a relationship between a curvature of a curve and a length of the curve.

FIG. 3 is a schematic diagram illustrating a length of the curve in a center of a travelling road in a width direction and a length of the curve in a center of a travelling lane in a width direction.

FIG. 4 is a diagram illustrating a tendency of a threshold value change with respect to a curvature change of the curve.

FIG. 5 is a flowchart illustrating a flow of necessity determination processing of the deceleration control in the first embodiment.

FIG. 6 is a diagram illustrating a schematic configuration of a vehicle on which a vehicle travel control device is mounted in a second embodiment.

FIG. 7A is a diagram illustrating a trend of the threshold value change with respect to a cant change in the curve in a case where the curve slopes downward from the outside of the curve toward the inside thereof. FIG. 7B is a diagram illustrating a trend of the threshold value change with respect to a cant change in the curve in a case where the curve slopes downward from the inside of the curve toward the outside thereof.

FIG. 8 is a flowchart illustrating a flow of determining a necessity of the deceleration control in the second embodiment.

FIG. 9 is a diagram illustrating a schematic configuration of a vehicle on which a vehicle travel control device is mounted in a third embodiment.

FIG. 10A is a diagram illustrating a trend of the threshold value change with respect to the vertical gradient change in the curve in a case where the curve has a vertical gradient of an upward slope. FIG. 10B is a diagram illustrating a trend of the threshold value change with respect to the vertical gradient change in the curve in a case where the curve has a vertical gradient of a downward slope.

FIG. 11 is a flowchart illustrating a flow of determining a necessity of the deceleration control in the third embodiment.

### DESCRIPTION OF THE PREFERRED EMBODIMENTS

Hereinafter, embodiments of the present invention will be described with reference to the drawings. In describing the drawings, the same signs are given to the same elements and the description thereof will not be repeated.

### First Embodiment

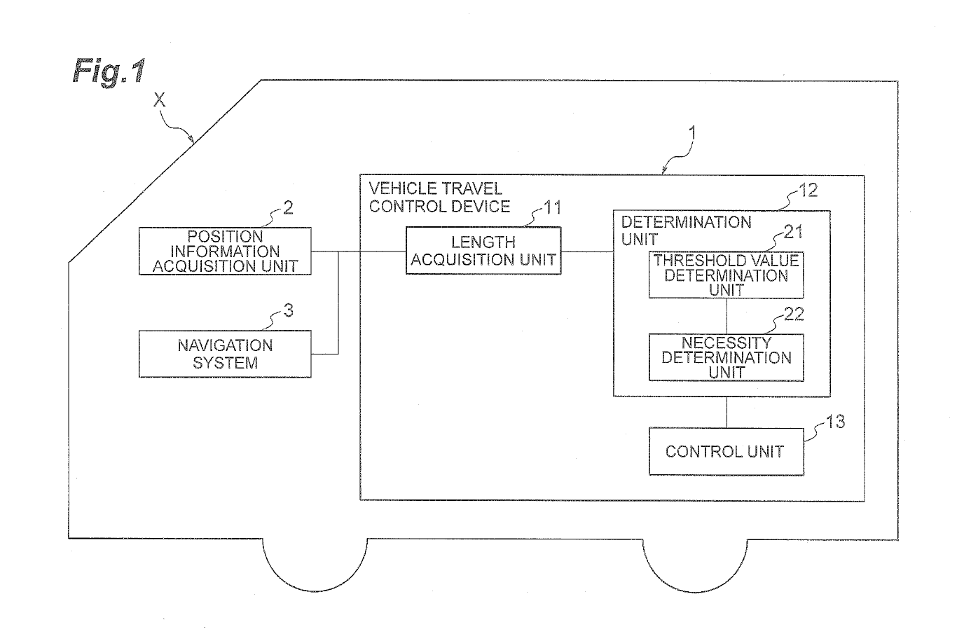

A first embodiment will be described. As illustrated in FIG. 1, a vehicle travel control device 1, a position information acquisition unit 2, and a navigation system 3 are included in a vehicle X. The position information acquisition unit 2 acquires position information of the vehicle X. As the position information acquisition unit 2, for example, a global positioning system (GPS) can be used. The navigation system 3 stores map information. A position where a road is installed and a curvature of the road are included in the map information. In addition, for example, a width of a lane may be included in the map information. As the curvature of the road, curvature values are associated with the road for each predetermined distance on the map information. The curvature of the road is, for example, a curvature at the center of a travelling road in the width direction (as an example, the curvature at a center line of the travelling road). The navigation system 3 can provide information of the road around the vehicle X to the driver through a monitor. In addition, the navigation system 3 can also perform route guidance to the set destination.

The vehicle travel control device 1 can execute a deceleration control of the vehicle X based on the curvature of the curve in front of the vehicle X. The vehicle travel control device 1 includes an electronic control unit (ECU) used for controlling the travel of the vehicle. The ECU is an electronic control unit having a central processing unit (CPU), read only memory (ROM), random access memory (RAM), and the like. The ECU executes various controls by loading a program stored in the ROM on the RAM and executing the program in the CPU. The ECU may be configured to include a plurality of electronic control units.

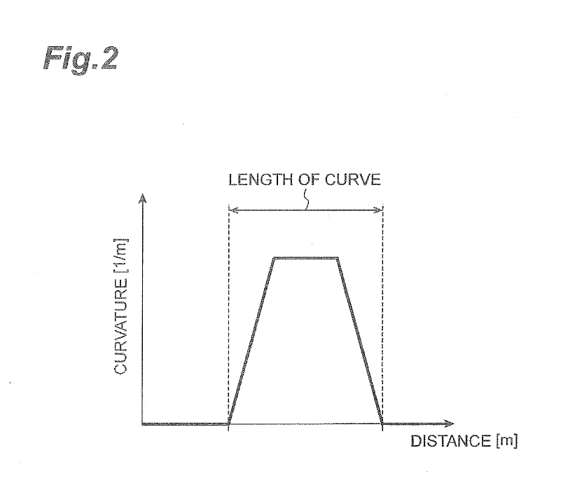

The vehicle travel control device 1 is configured to functionally include a length acquisition unit 11, a determination unit 12, and a control unit 13. The length acquisition unit 11 acquires a length of the curve in front of the vehicle X based on the map information around the vehicle X. Here, the curve means a section which is interposed between a straight road and a straight road and has a curvature. The straight road means a section of which the curvature is zero. Here, FIG. 2 is a diagram illustrating a relationship between the curvature of the curve and the length of the curve. As illustrated in FIG. 2, the length of the curve means a length of the section having the curvature.

Such as an S-shaped curve, there is a curve that includes a portion where the curvature is zero at the portion where the direction of the curve changes. In this case, the length of the curve means, for example, a length of a section from the point where the straight road starts to bend and the curvature starts to become a value other than zero to the point where the curvature becomes zero. That is, the length acquisition unit 11 recognizes the S-shaped curve as a combination of two curves that bend toward the directions different from each other, and may acquire the length of each curve.

The straight road may not be a section in which the curvature is zero, but may be a section in which the curvature is smaller than a predetermined value. In this case, the curve means the section in which the curvature exceeds the predetermined value.

The length acquisition unit 11 may acquire a length of the curve (for example, a length of the center line in the curve of the travelling road) at the center of the travelling road in the width direction as an example of the length of the curve in front of the vehicle X. Hereinafter, processing of acquiring length of the curve at the center of the travelling road in the width direction by the length acquisition unit 11 will be described. In the present embodiment, the length acquisition unit 11 acquires the length of the curve based on the map information or the like acquired by the navigation system 3.

Specifically, the length acquisition unit 11 acquires current position information of the vehicle X from the position information acquisition unit 2. The length acquisition unit 11 acquires the map information around the vehicle X from the navigation system 3 based on the acquired current position information of the vehicle X. The length acquisition unit 11 detects the travelling road of the vehicle X based on the acquired position information and the map information. The length acquisition unit 11 acquires the length of the travelling road in the section having a curvature in front of the vehicle X among the detected travelling road based on the map information acquired from the navigation system 3 as a length of the curve. In a case where there exists a plurality of curves on the travelling road in front of the vehicle X, the length acquisition unit 11 may acquire the length of the curve closest to the vehicle X as the length of the curve on the travelling road.

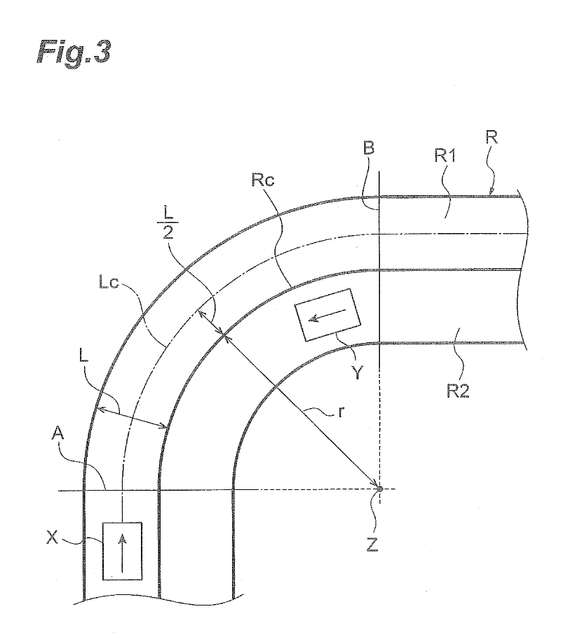

Here, as an example, a length of a curve of a travelling road in a case of one lane in each direction will be described using FIG. 3. A travelling road R illustrated in FIG. 3 is configured from a travelling lane R1 of the vehicle X and an opposing lane R2 on which an opposing vehicle Y travels. The travelling road R is curved from a point A to a point B toward the right direction seen from the vehicle X. The point A is a boundary point (entrance point to the curve) from a section (straight road) in which there is no curvature of the road to the section (curve) in which there is a curvature. The point B is a boundary point (the curve exit point) from the section (curve) in which there is a curvature to the section (straight road) in which there is no curvature of the road. The curvature of the curve of the road referred to here and acquired from the navigation system 3 is a curvature of the center line Rc at the center of the travelling road R in the width direction as illustrated in FIG. 3. That is, in FIG. 3, the length of the curve of the travelling road R acquired by the length acquisition unit 11 is the length of the center line Rc in the travelling road R between the point A and the point B.

In addition, the length acquisition unit 11 may acquire the length of the curve at the center of the travelling lane R1, instead of the travelling road R, of the vehicle X in the width direction as another example of the length of the curve in front of the vehicle X. The length of the curve at the center of the travelling lane R1 of the vehicle X in the width direction means a length of a virtual line Lc (a virtual line Lc passing through the center of the travelling lane R1 in the width direction) that connects the center of the travelling lane R1 in the width direction between the point A and the point B.

Here, the lane width of the travelling lane R1 is assumed to be L. The lane width L of the travelling lane R1 can be acquired, for example, from the map information of the navigation system 3 or by road-to-vehicle communication. The center line Rc of the travelling road R and the virtual line Lc of the travelling lane R1 are shifted each other by L/2. A radius (r) from a center Z of a circle that forms the center line Rc of the travelling road R to the center line Rc is already known by the curvature (1/r) of the travelling road R acquired from the navigation system 3. The center line Rc and the virtual line Lc are lines parallel to each other and the interval thereof is L/2. Therefore, as an example, the length acquisition unit 11 may acquire the length of the curve of the virtual line Lc using the interval L/2 between the length of the curve of the center line Rc of the travelling road R and the virtual line Lc of the travelling lane R1 by a well-known mathematical method.

In a case of acquiring a length of the curve at the center in the width direction of the travelling lane of the vehicle X in the travelling road having two lanes in each direction, it is preferable to determine which lane the vehicle X is travelling. In this case, for example, the travelling lane may be determined based on the travelling lane information acquired by the road-to-vehicle communication or the position information acquired by the position information acquisition unit 2. Communication between an optical beacon installed on the travelling road and the vehicle X is a sample of the road-to-vehicle communication.

Here, the lane width of each lane forming the two lanes in each direction is assumed to be L. In a case where the determined travelling lane of the vehicle X is a lane near the center line, the interval between the virtual line at the center of the travelling lane in the width direction and the center line of the travelling road is L/2. For this reason, as an example, the length acquisition unit 11 may acquire the length of the curve of the virtual line using the interval L/2 between the length of the curve of the center line of the travelling road and the virtual line of the travelling lane by a well-known mathematical method. In a case where the determined travelling lane of the vehicle X is a lane away from the center line, the interval between the virtual line at the center of the travelling lane in the width direction and the center line of the travelling road is 3L/2 (L/2+L). For this reason, as an example, the length acquisition unit 11 may acquire the length of the curve of the virtual line using the interval 3L/2 between the length of the curve of the center line of the travelling road and the virtual line of the travelling lane by a well-known mathematical method.

The determination unit 12 determines whether or not the deceleration control of the vehicle X is necessary in the curve based on the length of the curve acquired by the length acquisition unit 11. In a case where the length of the curve is short, the determination unit 12 determines that the deceleration control is unnecessary. In addition, the determination unit 12 more easily determines that the deceleration control is unnecessary when the curvature of the curve becomes small (a gentle curve).

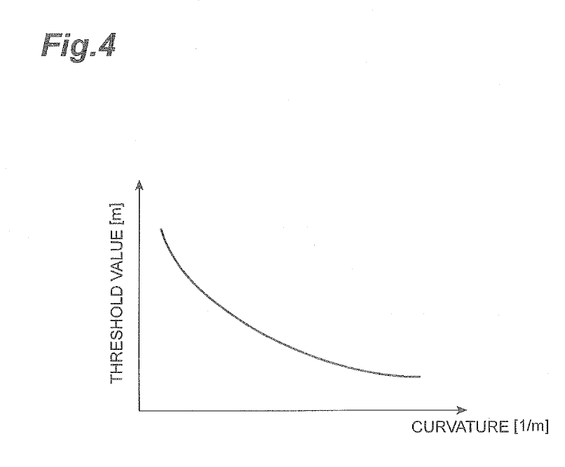

Specifically, the determination unit 12 is configured to include a threshold value determination unit 21 and a necessity determination unit 22. The threshold value determination unit 21 determines a threshold value that is used for determining the necessity of the deceleration control based on the curvature of the curve in front of the vehicle X. For example, in a case where the curvature of the curve is changed in the course of the curve, the maximum value of the curvature in the course of the curve is used for determining the threshold value. The threshold value determination unit 21 determines the threshold value based on the curvature of the curve in front of the vehicle X, as an example, according to a tendency of the threshold value change with respect to the curvature change of the curve illustrated in FIG. 4. That is, the threshold value determination unit 21 determines the threshold value to be a larger value when the curvature of the curve in front of the vehicle X becomes smaller.

The threshold value determination unit 21 may use the maximum value of the curvature of the travelling road included in the map information acquired from the navigation system 3 as the curvature of the curve. Alternatively, the threshold value determination unit 21 acquires the curvature of the virtual line Lc at the center of the travelling lane R1 of the vehicle X in the width direction based on the curvature of the travelling road included in the map information and the lane width of the travelling lane. Then, the threshold value determination unit 21 may use the maximum value of the curvature of the curve in the virtual line Lc in the acquired travelling lane R1 of the vehicle X as the curvature of the curve.

In a case where the length of the curve acquired by the length acquisition unit 11 is shorter than the threshold value determined by the threshold value determination unit 21, the necessity determination unit 22 determines that the deceleration control of the vehicle X is unnecessary. Conversely, in a case where the length of the curve acquired by the length acquisition unit 11 is equal to or longer than the threshold value determined by the threshold value determination unit 21, the necessity determination unit 22 determines that the deceleration control of the vehicle X is necessary.

In a case where it is determined by the necessity determination unit 22 of the determination unit 12 that the deceleration control of the vehicle X in the curve is necessary, the control unit 13 executes the deceleration control of the vehicle X. In a case where it is determined by the necessity determination unit 22 of the determination unit 12 that the deceleration control of the vehicle X in the curve is unnecessary, the control unit 13 does not execute the deceleration control of the vehicle X. As an example of the deceleration control, the control unit 13 calculates a target vehicle speed for the vehicle X to appropriately travel on the curve based on the curvature of the curve in front of the vehicle X. In a case where the current speed of the vehicle X is higher than the target vehicle speed, the control unit 13 may cause the vehicle to decrease the speed of the vehicle X by controlling the engine or the brake such that the speed becomes the target vehicle speed. The control unit 13 makes the target vehicle speed lower when the curvature of the curve becomes larger.

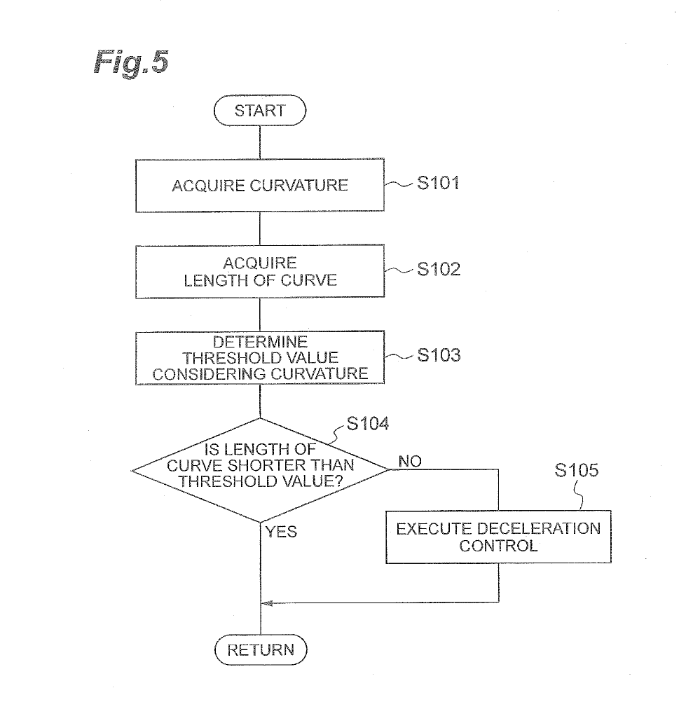

Next, the flow of necessity determination processing of the deceleration control of the vehicle X performed in the vehicle travel control device 1 will be described. FIG. 5 is a flowchart illustrating a flow of necessity determination processing of the deceleration control. As illustrated in FIG. 5, the length acquisition unit 11 acquires the map information including the curvature of the road from the navigation system 3 (STEP S101). The length acquisition unit 11 acquires the length of the curve in front of the vehicle X based on the curvature of the road included in the acquired map information (STEP S102). The threshold value determination unit 21 determines the threshold value used for determining the necessity of deceleration control based on the curvature of the curve (STEP S103). The necessity determination unit 22 determines whether or not the length of the curve acquired by the length acquisition unit 11 is shorter than the threshold value (STEP S104).

In a case where the length of the curve is shorter than the threshold value (YES in STEP S104), the necessity determination unit 22 determines that the deceleration control is unnecessary. In a case where the deceleration control is determined to be unnecessary, the length acquisition unit 11 performs again the above-described processing in STEP S101. That is, the control unit 13 does not execute the deceleration control of the vehicle X. In a case where the length of the curve is not shorter than the threshold value (NO in STEP S104), the necessity determination unit 22 determines that the deceleration control is necessary. Then, the control unit 13 executes the deceleration control of the vehicle X (STEP S105). After performing the deceleration control, the length acquisition unit 11 performs the above-described processing in STEP S101 again.

In the present embodiment, the configuration is as described above, and in a case where the length of the curve acquired by the length acquisition unit 11 is shorter than the threshold value, the necessity determination unit 22 determines that the deceleration control of the vehicle X is unnecessary. That is, in the short curve where the necessity of deceleration is low, the deceleration control of the vehicle X is not executed. Therefore, the vehicle travel control device 1 can suppress the uncomfortable feeling to the driver caused by the deceleration control of the vehicle in the curve.

The threshold value determination unit 21 determines the threshold value used for determining the necessity of deceleration control to be larger when the curvature of the curve becomes smaller. In this case, for example, even if the lengths of the curve in the two cases below are the same, it is more easily determined that the deceleration control of the vehicle X is unnecessary in a case where the curvature of the curve is small and the necessity of the deceleration is low (in a case of gentle curve) than in a case where the curvature of the curve is large (in a case of steep curve). In this manner, by the vehicle travel control device 1 more easily determining that the deceleration control is unnecessary when the curvature of the curve becomes smaller, it is possible to suppress the uncomfortable feeling to the driver caused by the low-necessity deceleration control.

### Second Embodiment

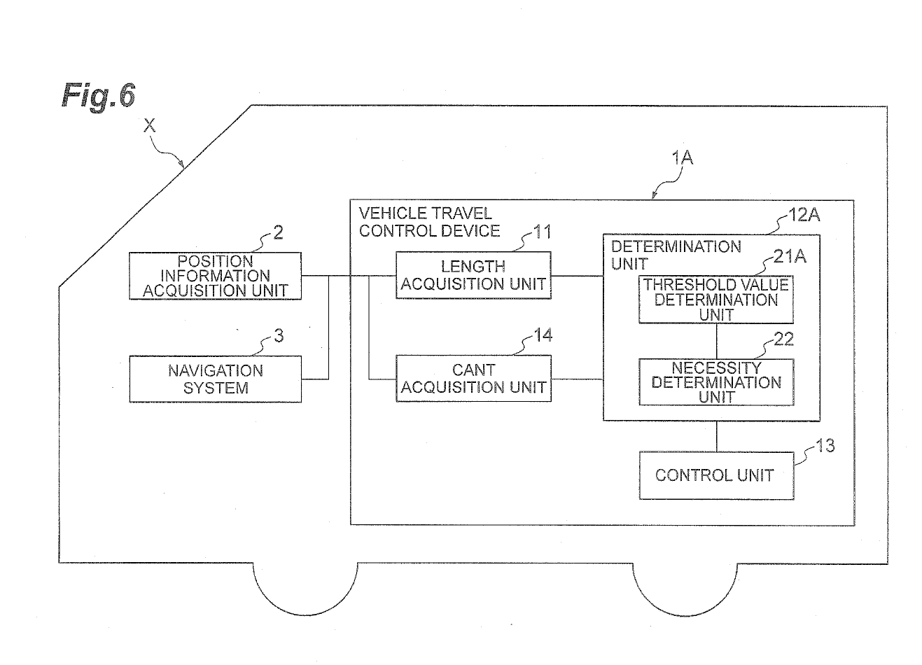

A second embodiment will be described. As illustrated in FIG. 6, the vehicle travel control device 1A in the second embodiment is configured to include a length acquisition unit 11, a determination unit 12A, a control unit 13, and a cant acquisition unit 14. In the vehicle travel control device 1A in the second embodiment, a determination method of the threshold value used in determining the necessity of deceleration control is mainly different from the method in the vehicle travel control device 1 in the first embodiment.

The cant acquisition unit 14 acquires a cant (horizontal slope) in the curve in front of the vehicle X. In the present embodiment, a direction of the cant of the road and the cant value of the road are also included in the map information stored in the navigation system 3 in addition to the position where the road is provided and the curvature of the road. The direction of the cant and the cant value of the road are associated with each other, for example, for each predetermined distance to the road on the map information. Specifically, the cant acquisition unit 14 acquires the current position information of the vehicle X from the position information acquisition unit 2. The cant acquisition unit 14 acquires the map information around the vehicle X from the navigation system 3 based on the acquired current position information of the vehicle X. The cant acquisition unit 14 detects a curve in front of the vehicle X based on the acquired position information and the map information. The cant acquisition unit 14 acquires the value and the direction of the cant in the curve in front of the vehicle X based on the map information acquired from the navigation system 3. In a case where the cant changes in the course of the curve, the maximum cant value in the course of the curve may be used as the cant value.

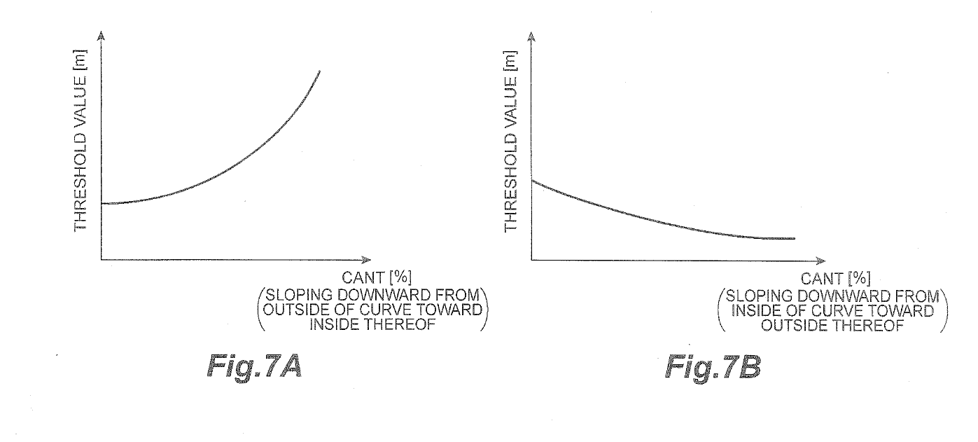

The determination unit 12A is configured to include a threshold value determination unit 21A and the necessity determination unit 22. The threshold value determination unit 21A determines the threshold value used for determining the necessity of deceleration control based on the direction of the cant and the cant value in the curve acquired by the cant acquisition unit 14. The threshold value determination unit 21A determines the threshold value based on the cant in the curve in front of the vehicle X according to, as an example, the trend of the threshold value change with respect to the cant change illustrated in FIG. 7A and FIG. 7B. The trend of the threshold value change illustrated in FIG. 7A is a trend in a case where the cant sloping downward from the outside of the curve toward the inside of the curve is acquired by the cant acquisition unit 14. As illustrated in FIG. 7A, the threshold value determination unit 21A determines the threshold value to be larger when the cant sloping downward from the outside of the curve toward the inside of the curve becomes larger.

A trend of the threshold value change illustrated in FIG. 7B is a trend in a case where the cant sloping downward from the inside of the curve toward the outside of the curve is acquired by the cant acquisition unit 14. As illustrated in FIG. 7B, the threshold value determination unit 21A determines the threshold value to be smaller when the cant sloping downward from the inside of the curve toward the outside of the curve becomes larger.

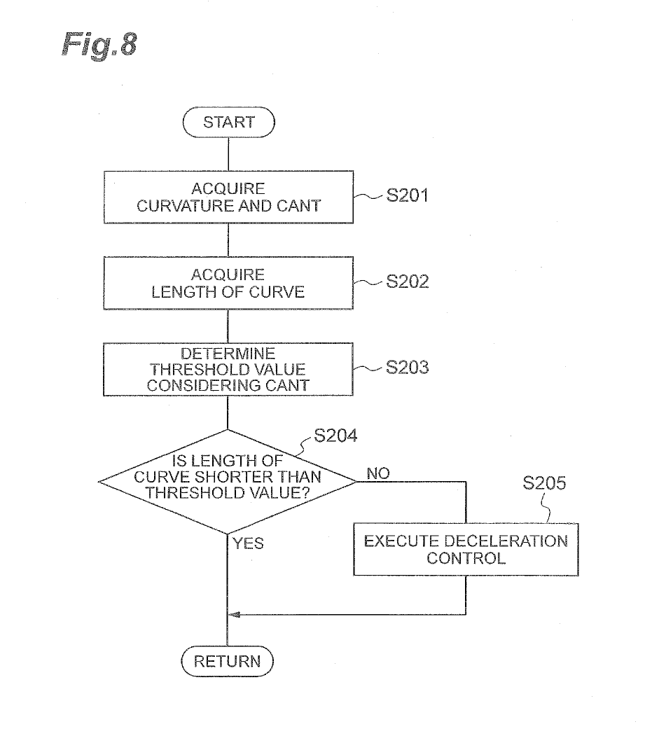

Next, a flow of necessity determination processing of the deceleration control of the vehicle X performed in the vehicle travel control device 1A will be described using FIG. 8. As illustrated in FIG. 8, the length acquisition unit 11 and the cant acquisition unit 14 acquire the map information including the curvature of the road and the direction of the cant and the cant value from the navigation system 3 (STEP S201). The length acquisition unit 11 acquires the length of the curve in front of the vehicle X based on the curvature of the road included in the acquired map information (STEP S202). The threshold value determination unit 21A determines the threshold value used for determining the necessity of deceleration control based on the direction of the cant and the cant value in the curve acquired by the cant acquisition unit 14 (STEP S203). The processing tasks in STEP S204 and STEP S205 are similar to those in STEP S104 and STEP S105 described in the first embodiment using FIG. 5, and the description thereof will not be repeated.

In the present embodiment, the configuration is as described above, and in a case where the cant sloping downward from the outside of the curve toward the inside of the curve is acquired by the cant acquisition unit 14, the threshold value determination unit 21A determines the threshold value to be larger when the cant becomes larger. In a case where the length of the curve acquired by the length acquisition unit 11 is shorter than the threshold value determined by the threshold value determination unit 21A, the necessity determination unit 22 determines that the deceleration control of the vehicle X is unnecessary.

According to the vehicle travel control device 1A, for example, even if the lengths of the curve in the two cases below are the same, it is more easily determined that the deceleration control of the vehicle X is unnecessary in a case where the cant sloping downward from the outside of the curve toward the inside thereof is large than in a case where the cant is small. Here, in a case where the cant sloping downward from the outside of the curve toward the inside thereof is large, it can be suppressed that the vehicle X departs from the travelling lane toward the outside of the curve, and thus, the necessity of decelerating the vehicle X is low. In this manner, the vehicle travel control device 1A more easily determines that the deceleration control is unnecessary when the cant sloping downward from the outside of the curve toward the inside thereof becomes larger. Therefore, it is possible to suppress the uncomfortable feeling to the driver caused by the low-necessity deceleration control.

In addition, in a case where the cant sloping downward from the inside of the curve toward the outside of the curve is acquired by the cant acquisition unit 14, the threshold value determination unit 21A determines the threshold value to be smaller when the cant becomes larger. For example, even if the lengths of the curve in the two cases below are the same, it is more easily determined that the deceleration control of the vehicle X is necessary in a case where the cant sloping downward from the inside of the curve toward the outside thereof is large than in a case the cant is small. Here, in a case where the cant sloping downward from the inside of the curve toward the outside thereof is large, since the vehicle X easily departs from the travelling lane toward the outside of the curve, the necessity of decelerating the vehicle X is high. As described above, the vehicle travel control device 1A makes it easier to determine that the deceleration control is necessary when the cant sloping downward from the inside of the curve toward the outside thereof becomes larger. Therefore, it is possible to execute the deceleration control according to the necessity of deceleration.

### Third Embodiment

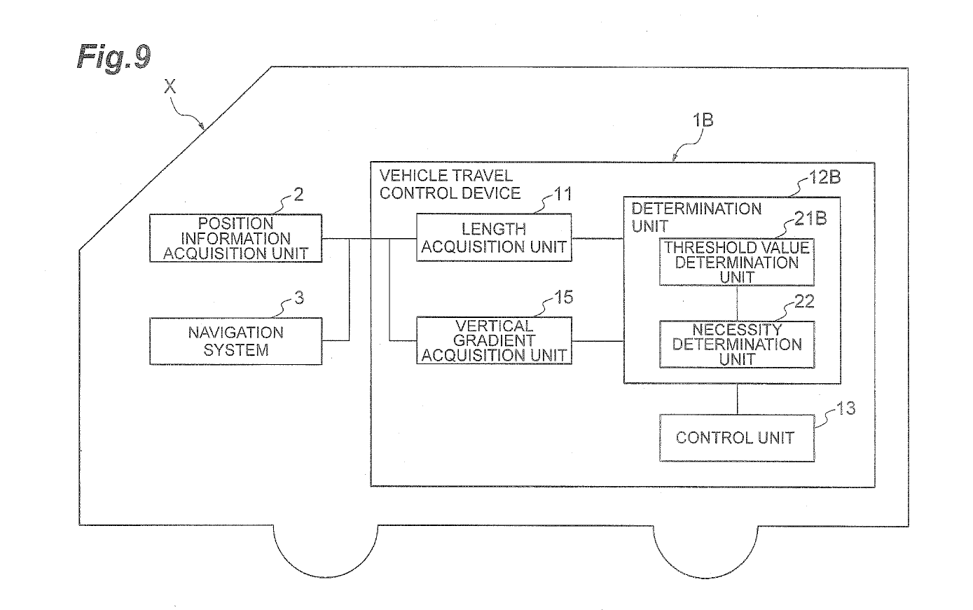

A third embodiment will be described. As illustrated in FIG. 9, a vehicle travel control device 1B in the third embodiment is configured to include a length acquisition unit 11, a determination unit 12B, a control unit 13, and a vertical gradient acquisition unit 15. In the vehicle travel control device 1B in the third embodiment, a determination method of the threshold value used in determining the necessity of deceleration control is mainly different from the method in the vehicle travel control device 1 in the first embodiment.

The vertical gradient acquisition unit 15 acquires a vertical gradient in the curve in front of the vehicle X. In the present embodiment, a direction of the vertical gradient and the vertical gradient value of the road are also included in the map information stored in the navigation system 3 in addition to the position where the road is provided and the curvature of the road. In the vertical gradient of the road, the direction of the vertical gradient and the vertical gradient value of the road are associated with, for example, each other for each predetermined distance to the road on the map information. Specifically, the vertical gradient acquisition unit 15 acquires the current position information of the vehicle X from the position information acquisition unit 2. The vertical gradient acquisition unit 15 acquires the map information around the vehicle X from the navigation system 3 based on the acquired current position information of the vehicle X. The vertical gradient acquisition unit 15 detects a curve in front of the vehicle X based on the acquired position information and the map information. The vertical gradient acquisition unit 15 acquires the direction and value of the vertical gradient in the curve in front of the vehicle X based on the map information acquired from the navigation system 3. In a case where the vertical gradient changes in the course of the curve, the maximum value of the vertical gradient value in the course of the curve may be used as the vertical gradient value.

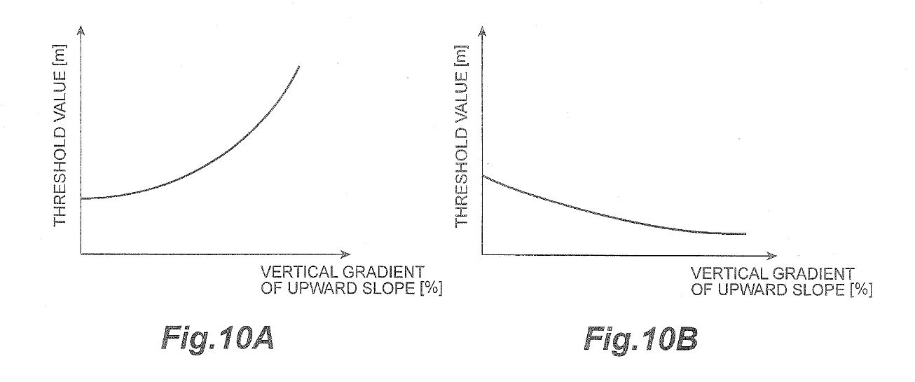

The determination unit 12B is configured to include a threshold value determination unit 21B, and a necessity determination unit 22. The threshold value determination unit 21B determines the threshold value used for determining the necessity of deceleration control based on the vertical gradient in the curve acquired by the vertical gradient acquisition unit 15. The threshold value determination unit 21B determines the threshold value based on the vertical gradient in the curve in front of the vehicle X according to, as an example, the trend of the threshold value change with respect to the vertical gradient change illustrated in FIG. 10A and FIG. 10B. The trend of the threshold value change illustrated in FIG. 10A is a trend in a case where the vertical gradient of an upward slope is acquired by the vertical gradient acquisition unit 15. As illustrated in FIG. 10A, the threshold value determination unit 21B determines the threshold value to be larger when the vertical gradient of the upward slope in the curve becomes larger.

A trend of the threshold value change illustrated in FIG. 10B is a trend in a case where the vertical gradient of a downward slope is acquired by the vertical gradient acquisition unit 15. As illustrated in FIG. 10B, the threshold value determination unit 21B determines the threshold value to be smaller when the vertical gradient of the downward slope of the curve becomes larger.

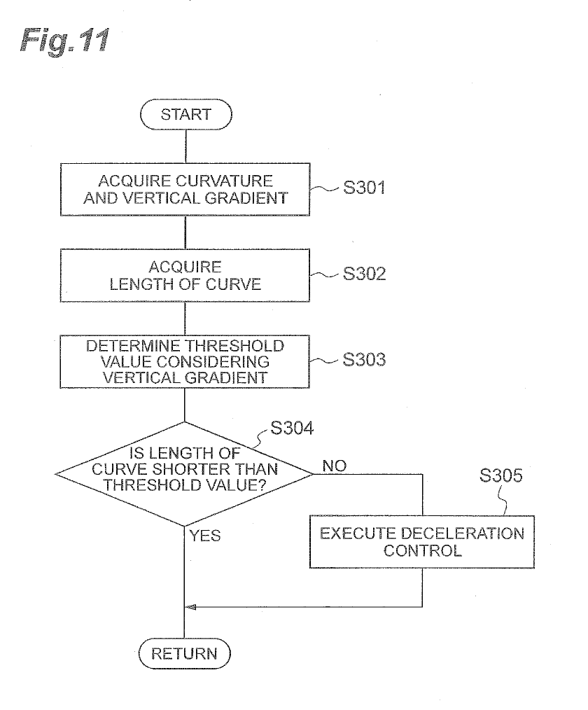

Next, a flow of necessity determination processing of the deceleration control of the vehicle X performed in the vehicle travel control device 1B will be described using FIG. 11. As illustrated in FIG. 11, the length acquisition unit 11 and vertical gradient acquisition unit 15 acquire the map information including the curvature of the road and the direction and value of the vertical gradient from the navigation system 3 (STEP S301). The length acquisition unit 11 acquires the length of the curve in front of the vehicle X based on the curvature of the road included in the acquired map information (STEP S302). The threshold value determination unit 21B determines the threshold value used for determining the necessity of deceleration control based on the direction and value of the vertical gradient in the curve acquired by the vertical gradient acquisition unit 15 (STEP S303). The processing tasks in STEP S304 and STEP S305 are similar to those in STEP S104 and STEP S105 described in the first embodiment using FIG. 5, and the description thereof will not be repeated.

In the present embodiment, the configuration is as described above, and in a case where the vertical gradient of the upward slope is acquired by the vertical gradient acquisition unit 15, the threshold value determination unit 21B determines the threshold value to be larger when the vertical gradient of the upward slope becomes larger. In a case where the length of the curve acquired by the length acquisition unit 11 is shorter than the threshold value determined by the threshold value determination unit 21B, the necessity determination unit 22 determines that the deceleration control of the vehicle X is unnecessary.

In this case, for example, even if the lengths of the curve in the two cases below are the same, it is more easily determined that the deceleration control of the vehicle X is unnecessary in a case where the vertical gradient of the upward slope is large and the necessity of deceleration is low than in a case where the vertical gradient is small. Here, in a case where the vertical gradient of the upward slope is large, since the speed of vehicle X is suppressed due to the upward slope, the necessity of decelerating the vehicle X is low. In this manner, the vehicle travel control device 1B makes it easier to determine that the deceleration control is unnecessary when the vertical gradient of the upward slope becomes larger. Therefore, it is possible to suppress the uncomfortable feeling to the driver caused by the low-necessity deceleration control.

In addition, in a case where the vertical gradient of the downward slope is acquired by the vertical gradient acquisition unit 15, the threshold value determination unit 21B determines the threshold value to be smaller when the vertical gradient of the downward slope becomes larger. In this case, for example, even if the lengths of the curve in the two cases below are the same, it is more easily determined that the deceleration control of the vehicle X is necessary in a case where the vertical gradient of the downward slope is large than in a case where the vertical gradient is small. Here, in a case where the vertical gradient of the downward slope is large, since speed of the vehicle X increases due to the downward slope, the necessity of decelerating the vehicle X is high. In this manner, vehicle travel control device 1B makes it easier to determine that the deceleration control is necessary when the vertical gradient of the downward slope becomes larger. Therefore, it is possible to execute the deceleration control according to the necessity of deceleration.

The embodiments of the present invention are described as above. However, including the above-described embodiments, the present invention can be embodied in various forms of modifications or improvements based on the knowledge of those skilled in the art. For example, in the first embodiment, the threshold value determination unit 21 determines the threshold value based on the curvature of the curve as the trend of the threshold value change illustrated in FIG. 4. Not limited to the changing threshold value, the threshold value determination unit 21 may use a predetermined constant value as the threshold value regardless of the curvature of the curve. Even in this case, in a short curve in which the necessity of deceleration is low, the deceleration control of the vehicle X is not performed. Therefore, the vehicle travel control device 1 makes it possible to suppress the uncomfortable feeling to the driver caused by the deceleration control in the curve.

In the first to third embodiments, when acquiring the length of the curve, the length acquisition unit 11 uses the curvature of the road included in the map information acquired by the navigation system 3. The method of acquiring the curvature of the road is not limited thereto. For example, the length acquisition unit 11 may communicate with a communication center at the outside of the vehicle to acquire map information including the curvature of the road from the communication center. The communication center is, for example, a traffic information management center that manages traffic information such as map information including the curvature of the road. The curvature of the road from the communication center may be, for example, a curvature (for example, an average value) that can be statistically obtained based on a travel history (steering history) of a plurality of vehicles.

In addition, as another example of acquiring the curvature of the road, the length acquisition unit 11 may use the travel history (steering history) at the time when the vehicle X travels on the road in the past. Specifically, the vehicle travel control device detects the curvature of the road when the vehicle X actually travels on the road. The detection of the curvature of the road may be performed for each predetermined distance. The vehicle travel control device may, for example, detect the curvature of the road based on the steering angle of the vehicle X. Then, the vehicle travel control device creates map information in which the result of detecting the curvature of the road and the position on the road in which the curvature of the road is detected are associated with each other, and stores the created map information. In this way, in a case of acquiring the curvature of the road in front of the vehicle X, the vehicle travel control device can use the stored map information instead of the map information acquired by the navigation system 3.

In the second embodiment, the cant acquisition unit 14 uses the cant of the road included in the map information acquired by the navigation system 3 as the cant in the curve. The method of acquiring the cant of the road is not limited thereto. For example, the cant acquisition unit 14 may communicate with the communication center outside of the vehicle to acquire the map information including the cant of the road from the communication center. The cant of the road from the communication center may be, for example, a cant (for example, an average value) that can be statistically obtained based on the result of detecting the cant (result of detecting by the inclination sensor) for each position on the road detected by a plurality of vehicles.

In addition, as another example of acquiring the cant of the road, the cant acquisition unit 14 may use the result of detecting the cant of the road detected when the vehicle X traveled on the road in the past. Specifically, the vehicle travel control device detects the cant of the road when the vehicle X actually travels on the road. The vehicle travel control device may detect the cant based on, for example, an inclination sensor that detects the inclination of the vehicle X. Then, the vehicle travel control device creates map information in which the result of detecting the cant of the road and the position on the road in which the cant is detected are associated with each other, and stores the created map information. In this way, in a case of acquiring the cant of the road in front of the vehicle X, the vehicle travel control device can use the stored map information instead of the map information acquired by the navigation system 3.

In the third embodiment, the vertical gradient acquisition unit 15 uses the vertical gradient of the road included in the map information acquired by the navigation system 3 as the vertical gradient in the curve. The method of acquiring the vertical gradient of the road is not limited thereto. For example, the vertical gradient acquisition unit 15 may communicate with the communication center outside of the vehicle to acquire the map information including the vertical gradient of the road from the communication center. The vertical gradient of the road from the communication center may be, for example, vertical gradient (for example, an average value) that can be statistically obtained based on the result of detecting the vertical gradient (result of detecting by the inclination sensor) for each position on the road detected by a plurality of vehicles.

In addition, as another example of acquiring the vertical gradient of the road, vertical gradient acquisition unit 15 may use the result of detecting the vertical gradient of the road detected when the vehicle X traveled on the road in the past. Specifically, the vehicle travel control device detects the vertical gradient of the road when the vehicle X actually travels on the road. The vehicle travel control device may detect the vertical gradient using, for example, the inclination sensor that detects the inclination of the vehicle X. Then, the vehicle travel control device creates map information in which the result of detecting the vertical gradient of the road and the position on the road in which the vertical gradient is detected are associated with each other, and stores the created map information. In this way, in a case of acquiring the vertical gradient of the road in front of the vehicle X, the vehicle travel control device can use the stored map information instead of the map information acquired by the navigation system 3.

In the first to third embodiments, the length acquisition unit 11 acquires the length of the curve based on the curvature of the road included in the map information acquired by the navigation system 3. However, the method of acquiring the length of the curve is not limited thereto. For example, the length of the curve may be included in the map information acquired from the navigation system 3 or the communication center. In this case, specifically, the position where the road is provided, the position of the curve, and the length of the curve are included in the map information. The length of the curve respectively associated with each curve on the road on the map information. In a case of acquiring the length of the curve, the length acquisition unit 11 acquires the current position information of the vehicle X from the position information acquisition unit 2. The length acquisition unit 11 acquires the map information around the vehicle X from the navigation system 3 or the communication center based on the acquired current position information of the vehicle X. The length acquisition unit 11 detects the curve in front of the vehicle X based on the acquired position information and the map information. The length acquisition unit 11 acquires the length of the curve in the curve in front of the vehicle X based on the map information acquired from the navigation system 3 or the communication center. The length of the curve included in the map information stored in the navigation system 3 may be the length of the curve at the center of the travelling road in the width direction, or may be the length of the curve at the center of the travelling lane of the vehicle X in the width direction. In a case of using the length of the curve at the center of the travelling lane of the vehicle X in the width direction in the travelling road having plural lanes in each direction, the length acquisition unit 11 determines which lane the vehicle X is travelling in in advance.

In addition, among the threshold value determination processing performed by the threshold value determination unit 21 in the first embodiment, the threshold value determination processing performed by the threshold value determination unit 21A in the second embodiment, and the threshold value determination processing performed by the threshold value determination unit 21B in the third embodiment, two or more determination processing tasks may be combined.

For example, a case of combining the threshold value determination processing performed by the threshold value determination unit 21 in the first embodiment and the threshold value determination processing performed by the threshold value determination unit 21A in the second embodiment will be described. In this case, the threshold value determination unit determines the threshold value based on the curvature of the curve and the cant in the curve.

For example, even if the cants in the curve are the same, the threshold value determination unit may determine the threshold value to be larger in a case where the curvature of the curve is small and the necessity of deceleration is low than in a case where the curvature of the curve is large. In this case, for example, even if the lengths of the curve and the cants in the curve in the two cases below are the same, the necessity determination unit more easily determines that the deceleration control of the vehicle X is unnecessary in a case where the curvature of the curve is small and the necessity of deceleration is low than in a case where the curvature of the curve is large.

For example, even if the curvature of the curve in the two cases below are the same, the threshold value determination unit may determine the threshold value to be larger in a case where the cant sloping downward from the outside of the curve toward the inside thereof is large than in a case where the cant is small. In this case, for example, even if the length of the curve and the curvature of the curve are the same, the necessity determination unit more easily determines that the deceleration control of the vehicle X is unnecessary in a case where the cant sloping downward from the outside of the curve toward the inside thereof is large than in a case where the cant is small. In addition, for example, even if the curvature of the curve in the two cases below are the same, the threshold value determination unit may determine the threshold value to be lower in a case where the cant sloping downward from the inside of the curve toward the outside thereof is large than in a case where the cant is small. In this case, for example, even if the lengths of the curve and the curvatures of the curve are the same in the two cases below, the necessity determination unit more easily determines that the deceleration control of the vehicle X is necessary in a case where the cant sloping downward from the inside of the curve toward the outside thereof is large than in a case where the cant is small.

For example, a case of combining the threshold value determination processing performed by the threshold value determination unit 21 in the first embodiment and the threshold value determination processing performed by the threshold value determination unit 21B in the third embodiment will be described. In this case, the threshold value determination unit determines the threshold value based on the curvature of the curve and the vertical gradient in the curve.

For example, even if the vertical gradients in the curve in the two cases below are the same, the threshold value determination unit may determine the threshold value to be larger in a case where the curvature of the curve is small and the necessity of deceleration is low than in a case where the curvature of the curve is large. In this case, for example, even if the lengths of the curve and the vertical gradients in the curve in the two cases below are the same, the necessity determination unit more easily determines that the deceleration control of the vehicle X is unnecessary in a case where the curvature of the curve is small and the necessity of deceleration is low than in a case where the curvature of the curve is large.

For example, even if the curvatures of the curve in the two cases below are the same, the threshold value determination unit may determine the threshold value to be larger in a case where the vertical gradient of the upward slope is large and the necessity of deceleration is low than in a case where the vertical gradient is small. In this case, for example, even if the lengths of the curve and the curvatures of the curve in the two case below are the same, the necessity determination unit more easily determines that the deceleration control of the vehicle X is unnecessary in a case where the vertical gradient of the upward slope is large and the necessity of deceleration is low than in a case where the vertical gradient is small. In addition, for example, even if the curvatures of the curve in the two cases below are the same, the threshold value determination unit may determine the threshold value to be smaller in a case where vertical gradient of the downward slope is large than in a case where the vertical gradient is small. In this case, even if the lengths of the curve and the curvatures of the curve in the two cases below are the same, the necessity determination unit more easily determines that the deceleration control of the vehicle X is necessary in a case where vertical gradient of the downward slope is large than in a case where the vertical gradient is small.

For example, a case of combining the threshold value determination processing performed by the threshold value determination unit 21A in the second embodiment and the threshold value determination processing performed by the threshold value determination unit 21B in the third embodiment will be described. In this case, the threshold value determination unit determines the threshold value based on the cant in the curve and the vertical gradient in the curve.

For example, even if the vertical gradients in the curve in the two cases below are the same, the threshold value determination unit may determine the threshold value to be larger in a case where the cant sloping downward from the outside of the curve toward the inside thereof is large than in a case where the cant is small. In this case, for example, even if the lengths of the curve and the vertical gradients in the curve in the two cases below are the same, the necessity determination unit more easily determines that the deceleration control of the vehicle X is unnecessary in a case where the cant sloping downward from the outside of the curve toward the inside thereof is large than in a case where the cant is small. In addition, for example, even if the vertical gradients in the curve in the two cases below are the same, the threshold value determination unit may determine the threshold value to be smaller in a case where the cant sloping downward from the inside of the curve toward the outside thereof is large than in a case where the cant is small. In this case, for example, even if the lengths of the curve and the vertical gradients in the curve in the two cases below are the same, the necessity determination unit more easily determines that the deceleration control of the vehicle X is necessary in a case where the cant sloping downward from the inside of the curve toward the outside thereof is large than in a case where the cant is small.

For example, even if the cants in the curve in the two cases below are the same, the threshold value determination unit may determine the threshold value to be larger in a case where the vertical gradient of the upward slope is large and the necessity of deceleration is low than in a case where the vertical gradient is small. In this case, for example, even if the lengths of the curve and the cants in the curve in the two cases below are the same, the necessity determination unit more easily determines that the deceleration control of the vehicle X is unnecessary in a case where the vertical gradient of the upward slope is large and the necessity of deceleration is low than in a case where the vertical gradient is small. In addition, for example, even if the cants in the curve in the two cases below are the same, the threshold value determination unit may determine the threshold value to be smaller in a case where the vertical gradient of the downward slope is large than in a case where the vertical gradient is small. In this case, for example, even if the lengths of the curve and the cants in the curve in the two cases below are the same, the necessity determination unit more easily determines that the deceleration control of the vehicle X is necessary in a case where the vertical gradient of the downward slope is large than in a case where the vertical gradient is small.

For example, a case of combining the threshold value determination processing performed by the threshold value determination unit 21 in the first embodiment, the threshold value determination processing performed by the threshold value determination unit 21A in the second embodiment, and the threshold value determination processing performed by the threshold value determination unit 21B in the third embodiment will be described. In this case, the threshold value determination unit determines the threshold value based on the curvature of the curve, the cant in the curve, and the vertical gradient in the curve.

For example, even if the cants and the vertical gradients in the curve in the two cases below are the same, the threshold value determination unit may determine the threshold value to be larger in a case where the curvature of the curve is small and the necessity of deceleration is low than in a case where the curvature of the curve is large. In this case, for example, even if the lengths of the curve, the cants and the vertical gradients in the curve in the two cases below are the same, the necessity determination unit more easily determines that the deceleration control of the vehicle X is unnecessary in a case where the curvature of the curve is small and the necessity of deceleration is low than in a case where the curvature of the curve is large.

For example, even if the curvatures of the curve and the vertical gradients in the curve in the two cases below are the same, the threshold value determination unit may determine the threshold value to be larger in a case where the cant sloping downward from the outside of the curve toward the inside thereof is large than in a case where the cant is small. In this case, for example, even if the lengths of the curve, the curvatures of the curve, and the vertical gradients in the curve in the two cases below are the same, the necessity determination unit more easily determines that the deceleration control of the vehicle X is unnecessary in a case where the cant sloping downward from the outside of the curve toward the inside thereof is large than in a case where the cant is small. In addition, for example, even if the curvatures of the curve and the vertical gradients in the curve in the two cases below are the same, the threshold value determination unit may determine the threshold value to be smaller in a case where the cant sloping downward from the inside of the curve toward the outside thereof is large than in a case where the cant is small. In this case, for example, even if the lengths of the curve, the curvatures of the curve, and the vertical gradients in the curve in the two cases below are the same, the necessity determination unit more easily determines that the deceleration control of the vehicle X is necessary in a case where the cant sloping downward from the inside of the curve toward the outside thereof is large than in a case where the cant is small.

For example, even if the curvatures of the curve and the cants in the curve in the two cases below are the same, the threshold value determination unit may determine the threshold value to be larger in a case where the vertical gradient of the upward slope is large and the necessity of deceleration is low than in a case where the vertical gradient is small. In this case, for example, even if the lengths of the curve, the curvatures of the curve, and the cants in the curve in the two cases below are the same, the necessity determination unit more easily determines that the deceleration control of the vehicle X is unnecessary in a case where the vertical gradient of the upward slope is large and the necessity of deceleration is low than in a case where the vertical gradient is small. In addition, for example, even if the curvatures of the curve and the cants in the curve in the two cases below are the same, the threshold value determination unit may determine the threshold value to be smaller in a case where vertical gradient of the downward slope is large than in a case where the vertical gradient is small. In this case, for example, even if the lengths of the curve, the curvatures of the curve, and the cants in the curve in the two cases below are the same, the necessity determination unit more easily determines that the deceleration control of the vehicle X is necessary in a case where vertical gradient of the downward slope is large than in a case where the vertical gradient is small.

What is claimed is:

1. A vehicle travel control device that is configured to be capable of executing a deceleration control of a vehicle based on a curvature of a curve in front of the vehicle, the device comprising:
a length acquisition unit that is configured to acquire a length of the curve based on map information around the vehicle;
a determination unit that is configured to determine that the deceleration control of the vehicle is necessary in a case where the length of the curve acquired by the length acquisition unit is equal to or larger than a threshold value, and to determine that the deceleration control of the vehicle is unnecessary in a case where the length of the curve acquired by the length acquisition unit is smaller than the threshold value; and
a control unit that is configured to execute the deceleration control of the vehicle in a case where it is determined by the determination unit that the deceleration control of the vehicle in the curve is necessary, and not to execute the deceleration control of the vehicle in a case where it is determined by the determination unit that the deceleration control of the vehicle in the curve is unnecessary.

2. The vehicle travel control device according to claim 1,
wherein the determination unit uses a larger value as the threshold value when the curvature of the curve becomes smaller.

3. The vehicle travel control device according to claim 1, further comprising:
a cant acquisition unit that is configured to acquire a cant in the curve,
wherein, in a case where a cant sloping downward from the outside of the curve toward the inside of the curve is acquired by the cant acquisition unit, the determination unit uses a larger value as the threshold value when the cant becomes larger.

4. The vehicle travel control device according to claim 1, further comprising:
a vertical gradient acquisition unit that is configured to acquire a vertical gradient in the curve,
wherein, in a case where a vertical gradient of an upward slope is acquired by the vertical gradient acquisition unit, the determination unit uses a larger value as the threshold value when the vertical gradient becomes larger.
